(19) United States
(12) Patent Application Publication
(10) Pub. No.: US 2021/0164565 A1
(43) Pub. Date: Jun. 3, 2021

(54) BELLOWS, ITS USE AND METHOD FOR ITS MANUFACTURE

(71) Applicant: Carl Freudenberg KG, Weinheim (DE)

(72) Inventors: Stefan Schirmer, Lehrte (DE); Rainer Knorr, Berlin (DE)

(21) Appl. No.: 17/109,183

(22) Filed: Dec. 2, 2020

(30) Foreign Application Priority Data
Dec. 2, 2019 (DE) 10 2019 132 692.3

(51) Int. Cl. F16J 3/04; B32B 5/18

(52) U.S. Cl. CPC F16J 3/041; B32B 2605/00; B32B 5/18

(57) ABSTRACT

A bellows includes: an at least two-layer construction including at least a first layer and at least a second layer. In an embodiment, the layers are inseparably interconnected due to a manufacturing process of the layers. In an embodiment, the layers comprise different materials and/or have different densities. In an embodiment, at least one of the layers comprises a TPE material.

### CROSS-REFERENCE TO PRIOR APPLICATION

Priority is claimed to German Patent Application No. DE 10 2019 132 692.3, filed on Dec. 2, 2019, the entire disclosure of which is hereby incorporated by reference herein.

### FIELD

The invention relates to a bellows, its use, and to a method for its manufacture.

### BACKGROUND

Bellows are generally known and are often composed of thermoplastic elastomers. The previously known bellows have a single-layer construction and are made from a blown tube, inter alia, by extrusion blow molding.

Due to the single-layer construction, a bellows often cannot be adequately adapted to the respective conditions of use. Inevitably, sub-regions of a single-layer bellows are also composed of the one material used, while another material would perhaps be more suitable for these sub-regions with regard to, for example, performance characteristics, weight minimization and economic manufacturability. In particular, if the material used is expensive, the bellows manufactured therefrom will also be expensive.

### SUMMARY

In an embodiment, the present invention provides a bellows, comprising: an at least two-layer construction including at least a first layer and at least a second layer.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic perspective view of a ready-to-use, three-layered bellows;

FIG. 1a is a schematic view showing the bellows of FIG. 1 with a section cut away for better illustration of the multi-layer construction;

FIG. 2 is an enlarged schematic sectional view through the three-layered bellows of FIG. 1; and

FIG. 3 is a schematic, further enlarged detail view of the bellows shown in FIG. 2.

### DETAILED DESCRIPTION

In an embodiment, the present invention improves a bellows and a method for its manufacture in such a way that the bellows has good performance characteristics over a long service life, can be better adapted to the respective conditions of use, and is simple and cost-effective to manufacture. In an embodiment, the present invention specifies a use of such a bellows.

To achieve the foregoing, a bellows is provided which has an at least two-layer construction including at least a first layer and at least a second layer.

In this connection, it is advantageous that that the different layers of the bellows are each functionally individualized. For example, each material is used only for the layer for which it also suitable/required to ensure good performance characteristics over a long service life. The multi-layer construction of the bellows eliminates the need to use a material that is overkill in terms of, for example, price, weight, and durability. Each layer can be made to satisfy the requirements needed to provide good performance characteristics over a long service life, taking particular account of economic manufacturability.

If one of the layers is made, for example, of a foamed plastic, as will be explained further below, then this saves material compared to an unfoamed material, thus making the bellows altogether more economical and easier to manufacture.

Due to the manufacturing process and the materials used, the layers are inseparably interconnected. For this purpose, it is preferred to use compatible materials such as TPC-EE, -ET and -EE with PBT or TPV with a PP matrix.

For example, TPC-EE with PBT has the advantage that this this combination is particularly heat-resistant, rigid, and dynamically suitable.

For example, TPV with a PP matrix, on the other hand, has the advantage that this this combination is particularly economical and sufficient for certain applications.

With such a design, the inventive bellows can be handled with the same ease as a bellows with only a single-layer construction. In particular, installation and removal of the bellows, as well as the performance characteristics of the bellows during its intended use, do not differ, or differ only advantageously, from good single-layer bellows.

The layers may be composed of different materials and/or have different densities. Such a design allows for many variations, so that such a bellows having an at least two-layer construction is particularly well adaptable to the requirements of each particular application.

To allow a bellows that is no longer needed to be recycled with greatest possible ease, it is provided that the layers be composed of compatible materials. This is also advantageous for a good interconnection of the layers. Examples of such compatible materials include the following:

PBT with TPC-EE,

PBT with TPC-ET,

PBT with TPC-ES,

PP with TPV (PP/EPDM) and other PP-based TPEs,

PA with PA/ACM and PA/AEM and other PA-based TPEs,

PA with PEBA.

Acronyms are as follows:

PA polyamide

ACM polyacrylate rubber

PEBA polyether block amide

PBT polybutylene terephthalate

AEM ethylene-polyacrylate rubber

TPC thermoplastic copolymer

EE ether-ester block polymer

ET ether-ether block polymer

ES ester-ester block polymer

PP polypropylene

TPV thermoplastic vulcanizate

EPDM ethylene-propylene diene rubber of the M group

The first three material combinations are preferably used for bellows on the drive shaft to seal constant-velocity joints. The other combinations rather find application in bellows for steering or other chassis parts; PP with TPV rather for lower temperature requirements; the combinations with PA preferably for high temperature requirements.

The materials mentioned are highly compatible in terms of recycling and strength because they are chemically similar. The strength and other properties of the recycled material are then similar to those of the materials of the individual layers.

Layers which are composed of the same material can be recycled particularly easily. This allows for pure-grade recycling. This is useful, particularly when at least one of the layers is composed of the same but foamed material.

One material that is in many cases particularly well suited for the manufacture of bellows is a TPE material. Bellows made of a TPE material have the advantage that they allow large deformations at low forces, as compared to conventional thermoplastic materials.

Therefore, it is preferably provided that at least one of the layers be composed of a TPE material.

Generally, the first layer and the second layer may be composed of different materials, the material of one of the layers being unfoamed and that of one of the layers being foamed.

Preferably, however, it may be provided that the first layer and the second layer be composed of the same material, the material of one of the layers being unfoamed and that of one of the layers being foamed.

For the same thickness, an unfoamed layer requires more material than a foamed layer. The unfoamed layer may, for example, form the outer layer of the bellows, whereas the foamed layer may form the inner layer or one of the inner layers. The relatively more sensitive layer is then effectively protected by the unfoamed and more resistant outer layer from external influences.

With a foamed layer, typically about 30% of material is saved as compared to an unfoamed layer, so that the bellows is more cost-effective to manufacture, yet has the required wall stability despite the reduced amount of material. This is achieved in that the required section modulus of a bellows wall having, for example, a solid-foamed-solid construction is achieved with only slightly increased wall thickness equal to a solid layer.

The foamed layer may be physically or chemically foamed.

A physically foamed layer has the advantage that it does not require the use of a blowing agent, which would, as it were, contaminate the plastic material. Physical foaming is accomplished by injecting a gas, such as air or nitrogen, into the molten material during extrusion.

A chemically foamed layer has the advantage of eliminating the need for a gas-injection unit in the production facility. Chemical foaming is accomplished by mixing a blowing agent into the plastic material.

Furthermore, an at least a two-layer construction including a foamed layer has the technical advantage over a single-layer, unfoamed construction that such bellows exhibit improved thermal insulation while still being recyclable if the foam is composed of the same polymer as the unfoamed layer. In addition, such a bellows has a reduced weight for the same stability, is radially softer and thus less sensitive to shock, and has improved diffusion characteristics, provided that suitable barrier layers are used.

The improved diffusion characteristics are advantageous if, for example, fat is present in the bellows and the oil of the fat is lost by diffusion, and thus also its lubricating properties. A suitable barrier layer prevents diffusion and retains the lubricating properties of the fat.

As previously described, the first layer may be composed of an unfoamed material, and the second layer may be composed a foamed material. In order to protect, to the extent possible, the second layer made from the foamed material from undesirable influences, it may be provided that the second layer be sandwiched between the first layer and a third layer. Then, the foamed second layer no longer comes into contact with the inner and outer environments of the bellows and is protected in the best possible way.

The third layer and the first layer may be formed of a uniform material.

A bellows that is best suited for recycling is one where all layers are composed of an identical material, the material of the first and third layers preferably being unfoamed, and, on the other hand, the material of the second layer preferably being foamed.

With a view to providing a simple and reliable method for manufacturing the bellows, it may be provided that the first layer and the third layer each have a substantially constant wall thickness. In this connection, it is advantageous that all regions of a respective layer can be manufactured easily and free from manufacturing-related defects, and that, therefore, the bellows has good and predictable performance characteristics over a long service life.

Further, it is advantageous if the first layer and the third layer have substantially identical wall thicknesses. During the manufacturing process, these layers behave substantially identically in terms of solidification and/or shrinkage.

The wall thickness of the second layer is preferably greater than the wall thickness of the first and third layers if the generally expensive functional layers are on the outside. The wall thickness of the second layer is preferably less than the outer ones if it has high strength and a higher modulus of elasticity than the outer layers. It then has a strength-enhancing character and has the least possible adverse effect on the flexibility. The same applies to barrier layers which reduce the permeability if the material thereof has a higher modulus of elasticity.

For most applications, for example in the automotive field, the layers have wall thicknesses of 0.3 mm to 3 mm. If the wall thicknesses are thinner, the durability of the bellows during its intended use is reduced, whereas if the wall thicknesses are thicker, the bellows often no longer has the required flexibility.

A bellows having a multi-layer construction can be used particularly advantageously as an axle boot or a steering-rack boot of a motor vehicle. Such use is particularly advantageous because, due to the multi-layer construction, the bellows can be provided with layers having different properties, thus making it possible to meet the technical requirements in the best possible way. The technical requirements are low weight, good thermal insulation, low friction, low noise generation, low oil permeability, increased service life.

The aforementioned advantages may also be advantageous for other applications, such as for a bellows for the steering gear of a motor vehicle, a protective bellows for a suspension strut of a motor vehicle, or a stop bellows disposed externally or internally of a suspension strut of a motor vehicle.

The bellows may additionally have a substantially cylindrical portion to increase stability.

The invention further relates to a method for manufacturing a bellows having an at least two-layer construction, including at least a first layer and at least a second layer, where all layers are simultaneously manufactured by coextrusion in a common coextrusion tool and, owing to the manufacturing process, are brought together to form the bellows and, in connection with the already mentioned advantageous compatibility of the materials, are thereby inseparably interconnected. The coextrusion process is essentially as easy to perform as the extrusion blow molding of a single-walled component. Molten polymer is fed by a screw through dies, so that a tubular semi-finished product is formed. This tubular semi-finished product is then expanded in a blow mold and thereby conformed to the inner contour of the blow mold.

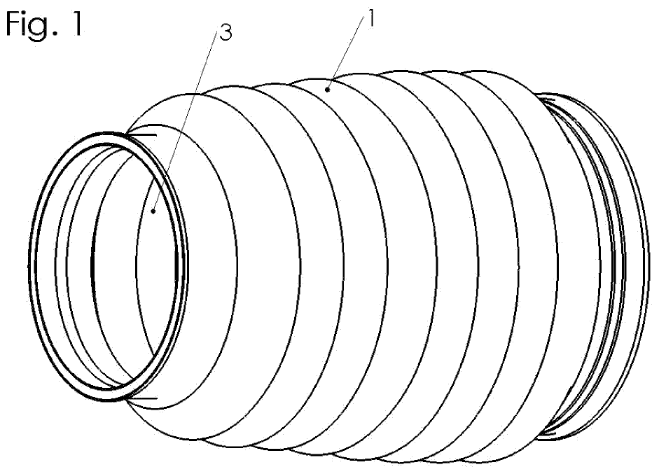

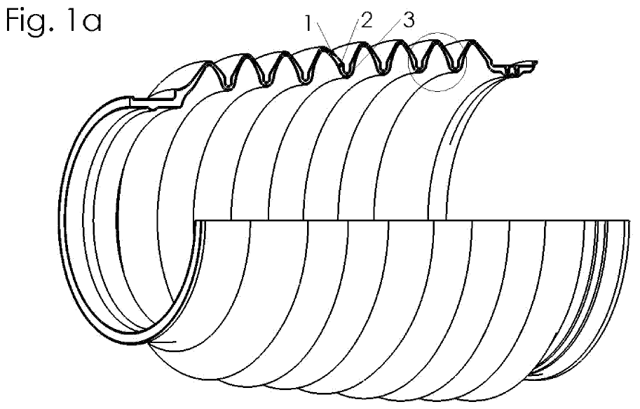

FIGS. 1 through 3 show an exemplary embodiment of an inventive bellows having a three-layer construction including a first layer 1, a second layer 2, and a third layer 3.

FIG. 1 shows the bellows in a perspective view. The bellows is used as an axle boot in a motor vehicle and is configured as a corrugated bellows.

FIG. 1a shows the bellows of FIG. 1 with a 90°-section cut away, thereby illustrating the multi-layer construction of the bellows.

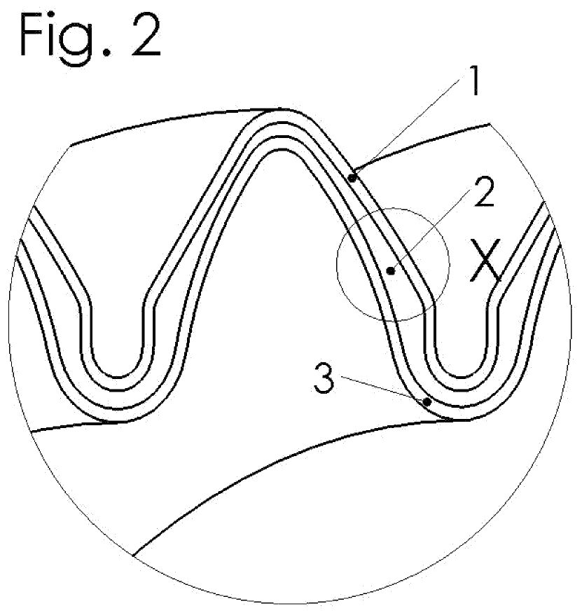

FIG. 2 shows a section through a fold of the bellows of FIG. 1.

The bellows has a three-layer construction and includes the first layer 1, the second layer 2, and the third layer 3. Due to the manufacturing process, all three layers 1, 2, 3 are inseparably interconnected and are composed of an identical TPE material.

By forming the bellows from a uniform material, it is readily recyclable to a pure-grade material. Alternatively, the three layers 1, 2, 3 are composed of different compatible materials having the aforementioned different properties.

First layer 1 and third layer 3 are disposed on the opposite sides of second layer 2, the bellows being constructed in a sandwich-like manner. The middle, second layer 2 is composed of a foamed material, while first layer 1 and third layer 3 are composed of an unfoamed material. As a result, second layer 2 has a lower density than the two adjacent layers 1, 3.

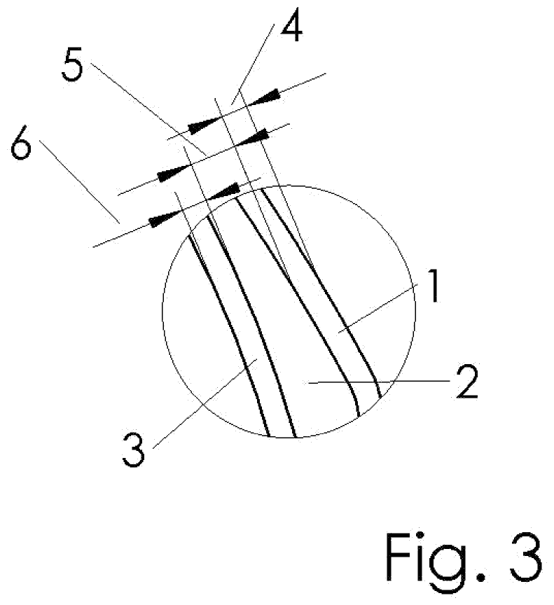

FIG. 3 shows detail “X” from FIG. 2 on enlarged scale.

In the exemplary embodiment shown, each layer 1, 2, 3 has a substantially constant wall thickness 4, 5, 6, respectively, and, in addition, all layers 1, 2, 3 have substantially identical wall thicknesses 4, 5, 6. Due to the substantially constant wall thicknesses of each layer, and because all layers 1, 2, 3 have substantially identical wall thicknesses 4, 5, 6, the bellows can be readily manufactured by coextrusion in a reliable process.

It is noted that in particular the foamed second layer 2 is particularly advantageous. Because of the comparatively low density, material is saved as compared to the two adjacent layers 1, 3, so that the illustrated bellows is easy to manufacture and light of weight.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A bellows, comprising:
an at least two-layer construction including at least a first layer and at least a second layer.

2. The bellows as recited in claim 1, wherein the layers are inseparably interconnected due to a manufacturing process of the layers.

3. The bellows as recited in claim 1, wherein the layers comprise different materials and/or have different densities.

4. The bellows as recited in claim 1, wherein at least one of the layers comprises a TPE material.

5. The bellows as recited in claim 1, wherein the first layer and the second layer comprise a same material,
wherein a material of one of the layers is unfoamed, and
wherein one of the layers is foamed.

6. The bellows as recited in claim 1, wherein the first layer comprises an unfoamed material,
wherein the second layer comprises a foamed material, and
wherein the second layer is sandwiched between the first layer and a third layer.

7. The bellows as recited in claim 6, wherein the third layer and the first layer are comprised of a uniform material.

8. The bellows as recited in claim 6, wherein the first layer and the third layer each have a substantially constant wall thickness.

9. The bellows as recited in claim 6, wherein the first layer and the third layer have substantially identical wall thicknesses.

10. The bellows as recited in claim 6, wherein a wall thickness of the second layer is greater than wall thicknesses of the first layer and the third layer.

11. The bellows as recited in claim 8, wherein the wall thicknesses of the first layer and third layer are each 0.3 mm to 3 mm.

12. A method, comprising:
using the bellows according to claim 1 as an axle boot or a steering-rack boot of a motor vehicle.

13. A method for manufacturing a bellows having an at least two-layer construction including at least a first layer and at least a second layer, comprising:
simultaneously manufacturing all layers by coextrusion in a common coextrusion tool; and
bringing together all layers to form the bellows such that all layers are inseparably interconnected due to simultaneously manufacturing.
